(19) United States
(12) Patent Application Publication
(10) Pub. No.: US 2005/0218866 A1
(43) Pub. Date: Oct. 6, 2005

(54) Apparatus for storing rechargers

(76) Inventor: Domenico A. Caminiti, Bakersfield, CA (US)

Correspondence Address: James M. Duncan;Klein, DeNatale, Goldner, Cooper,, Rosenlieb & Kimball, LLP, P.O. Box 11172, Bakersfield, CA, 93389-1172, US

(21) Appl. No.: 11/093,823

(22) Filed: Mar. 29, 2005

Related U.S. Application Data
(60) Provisional application No. 60/558,537, filed on Apr. 1, 2004.

(51) Int. Cl. H02J 7/00

(52) U.S. Cl. 320/108

(57) ABSTRACT

An apparatus to be used in combination with a recharging transformer comprises a bottom and a plurality of side pieces attached to and adjoining the bottom, where the side pieces form an opening. An intermediate panel is supported within the housing by one or more of the side pieces. The intermediate panel is adapted to retain an alternating current outlet which provides the current source for the recharging transformer. A first aperture provides access for the direct current outlet lead from the recharging transformer to the exterior of the housing. A power cord has a first end connected to the alternating current outlet inside the housing and a second end extends through a second aperture to the exterior of the housing, where the power cord terminates with a plug for plugging into an exterior source of alternating current. A top fits over the opening of the housing.

### CROSS-REFERENCE TO RELATED APPLICATION

U.S. Provisional Application No. 60/558,537 for this invention was filed on Apr. 1, 2004 for which the inventor claims domestic priority.

### BACKGROUND OF THE INVENTION

The present invention generally relates to devices for recharging cellular phones, cameras, walkie-talkies, and other devices which operate on rechargeable batteries which are recharged by a recharging transformer having a primary voltage of 120 volts alternating current which is transformed and rectified into a low voltage dc current. The present invention more specifically relates to various embodiments of an apparatus which houses the recharging transformer and most of the dc outlet lead, but which retains the dc connector on the outside of the housing for convenient connection to the rechargeable device.

### SUMMARY OF THE INVENTION

The apparatus disclosed herein comprises a housing used in combination with a recharging transformer. The recharging transformer is the type which has an alternating current primary coil which is connected to an alternating current outlet. The recharging transformer further comprises a secondary alternating current coil, transforming the voltage of the primary coil to a reduced voltage. The recharging transformer further comprises means for rectifying the alternating current of the secondary coil into direct current, and a direct current lead for conducting the direct current from the transformer. One embodiment of the disclosed housing which is used in combination with this type of transformer comprises a bottom and a plurality of side pieces attached to and adjoining the bottom, where the side pieces form an opening. An intermediate panel is supported within the housing by one or more of the side pieces. The intermediate panel is adapted to retain the alternating current outlet which provides the current source for the recharging transformer. This embodiment of the housing further comprises a first aperture through which the direct current outlet lead from the recharging transformer extends to the exterior of the housing. This embodiment of the housing further comprises a power cord which has a first end connected to the alternating current outlet inside the housing, the cord extending through a second aperture to the exterior of the housing and terminating at a second end. The second end of the power cord is adapted to connect to an alternating current source, thereby providing current to the alternating current outlet disposed within the housing. A top fits over the opening of the housing.

### BRIEF DESCRIPTION OF THE DRAWINGS

FIG. 1 shows an exploded view of one embodiment of the housing apparatus.

FIG. 2 shows a front view of the apparatus depicted in FIG. 1.

FIG. 3 shows a top view of the apparatus depicted in FIG. 1.

FIG. 4 shows a side view of the apparatus depicted in FIG. 1.

FIG. 5 shows a back view of the apparatus depicted in FIG. 1.

FIG. 6 shows a bottom view of the apparatus depicted in FIG. 1.

FIG. 7 shows how a recharging transformer may be inserted within the housing apparatus depicted in FIG. 1.

FIG. 8 shows how a device operated by a rechargeable battery may be connected to the dc lead extending from the housing apparatus depicted in FIG. 1.

FIG. 9 shows how utility hooks on the apparatus depicted in FIG. 1 may be utilized.

FIG. 10 shows an exploded view of another embodiment of the housing apparatus.

FIG. 11 shows a front view of the apparatus depicted in FIG. 10.

FIG. 12 shows a top view of the apparatus depicted in FIG. 10.

FIG. 13 shows a side view of the apparatus depicted in FIG. 10.

FIG. 14 shows a back view of the apparatus depicted in FIG. 10.

FIG. 15 shows a bottom view of the apparatus depicted in FIG. 10.

FIG. 16 shows how multiple recharging transformers may be inserted within the housing apparatus depicted in FIG. 10.

FIG. 17 shows how multiple devices operated by rechargeable batteries may be connected to the dc leads extending from the housing apparatus depicted in FIG. 10.

FIG. 18 shows how utility hooks on the apparatus depicted in FIG. 10 may be utilized.

### DETAILED DESCRIPTION OF THE EMBODIMENTS

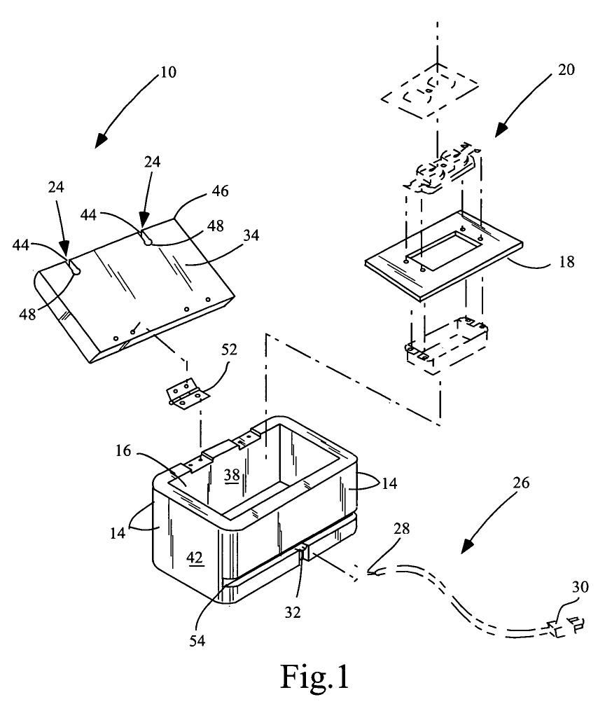

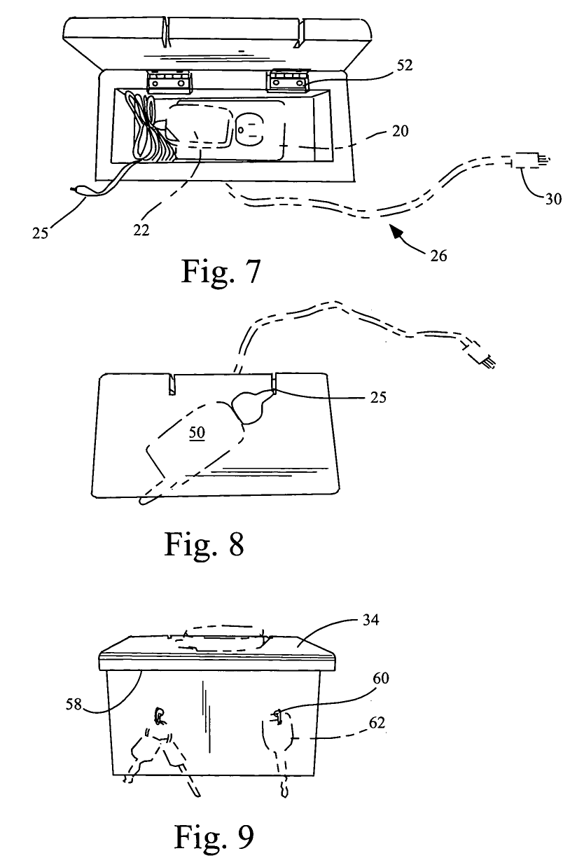

Referring now specifically to the drawings, FIG. 1 shows an exploded view of one embodiment 10 of the disclosed apparatus. This embodiment comprises a bottom 12 and a plurality of side pieces 14 attached to and adjoining the bottom, where the side pieces form an opening 16. An intermediate panel 18 is supported within the housing 10 by one or more of the side pieces 14. The intermediate panel 18 is adapted to retain the alternating current outlet 20 which provides the energy source for the recharging transformer 22 depicted in FIG. 7. This embodiment 10 of the housing further comprises a first aperture 24 which provides access for the direct current outlet lead 24 from the recharging transformer 22 to exit the interior of the housing. This embodiment of the housing further comprises a power cord 26 which has a first end 28 connected to the alternating current outlet 20 located inside the housing 10. The power cord 26 extends through a second aperture 32 and terminates at a second end 30 which is adapted to connect to an alternating current source, thereby providing current to the alternating current outlet disposed within the housing. A top 34 fits over the opening 16 of the housing 10.

As shown in FIGS. 1 through 6, the plurality of side pieces 14 may comprise a front panel 36, a back panel 38, a left side panel 40, and a right side panel 42. As further shown in FIGS. 1 through 6, the front panel 36 and back panel 38 may be parallel to one another. The front panel 36 and back panel 38 may also be rectangular in shape, wherein the term rectangular also includes square shapes. Likewise, left side panel 40 and right side panel 42 may be parallel to one another and also rectangular in shape. Top 34 may be rectangular. While FIGS. 1 through 6 generally depict front panel 36, back panel 38, left side panel 40, right side panel 42 and top 34 having these characteristics, it is to be appreciated that a housing might also comprise non-parallel and non-rectangular side pieces 14 and a non-rectangular top 34.

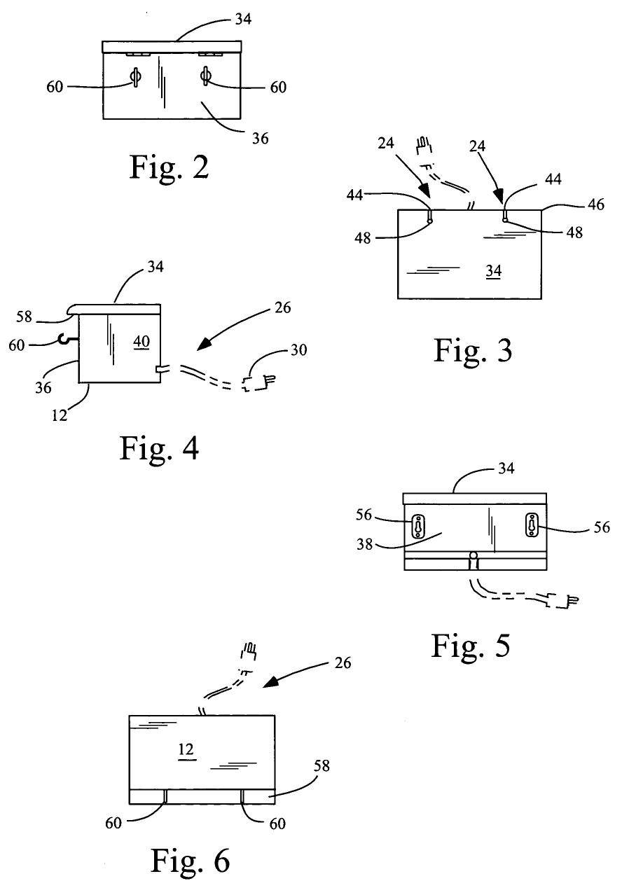

As shown in FIG. 1, first aperture 24 may be located in top 34. As shown in FIG. 1 and FIG. 2, first aperture 24 may comprise a restricted throat portion 44 which is initiated at the edge 46 of the top 34. From this restricted throat portion 44, the first aperture 24 may transition into an enlarged portion 48 further from the edge 46. The direct current outlet lead 24 may be inserted through restricted throat portion 44, however the restricted throat portion and the enlarged portion 48 will generally be small enough to retain the connector of lead from falling through the first aperture 24 when the connector is disconnected from the device 50, such as a cell phone, being recharged. The enlarged portion 48 allows top 34 to be opened without excessive friction between against the insulation of direct current outlet lead 24. As shown in FIG. 1, top 34 may be hingedly connected to front panel 36 with hinges 52.

As shown in FIG. 1 and FIG. 5, back panel 38 may comprise a cord groove 54 which originates at the second aperture 32 and terminates at one or more of the edges of the back panel. As shown in FIG. 1, the cord groove 54 may be tee-shaped and the second aperture located at the top bar of the tee. This configuration allows power cord 26 to be disposed within the cord groove 54 so that the back panel 38 may set flush against a flat surface, such as a wall, in the event this embodiment 10 of the apparatus is set against a wall or hung on a wall. This embodiment 10 may also comprise means for hanging the housing on a wall, such as hangers 56.

Top 34 may overhang front panel 36 as shown in FIG. 4, forming lip 58. Front panel 36 may be equipped with utility hooks 60 which may be used to hang various items 62, adding to the utility of the apparatus.

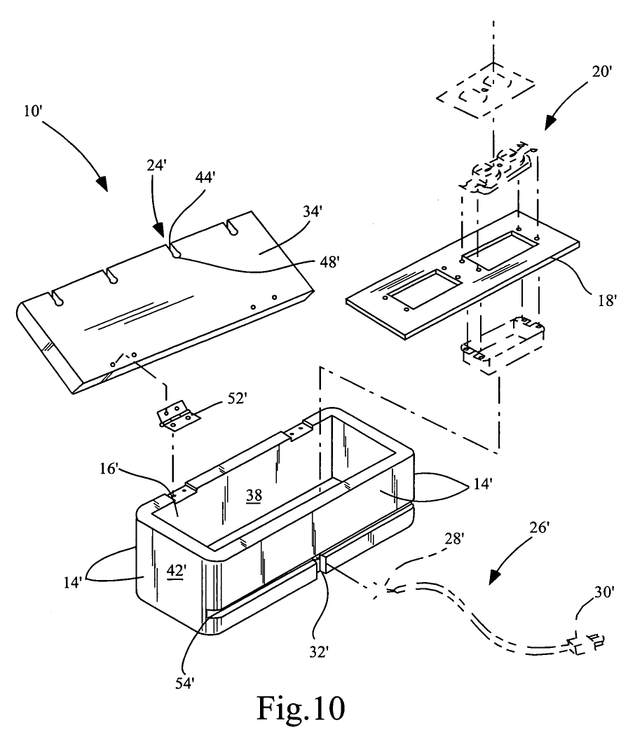

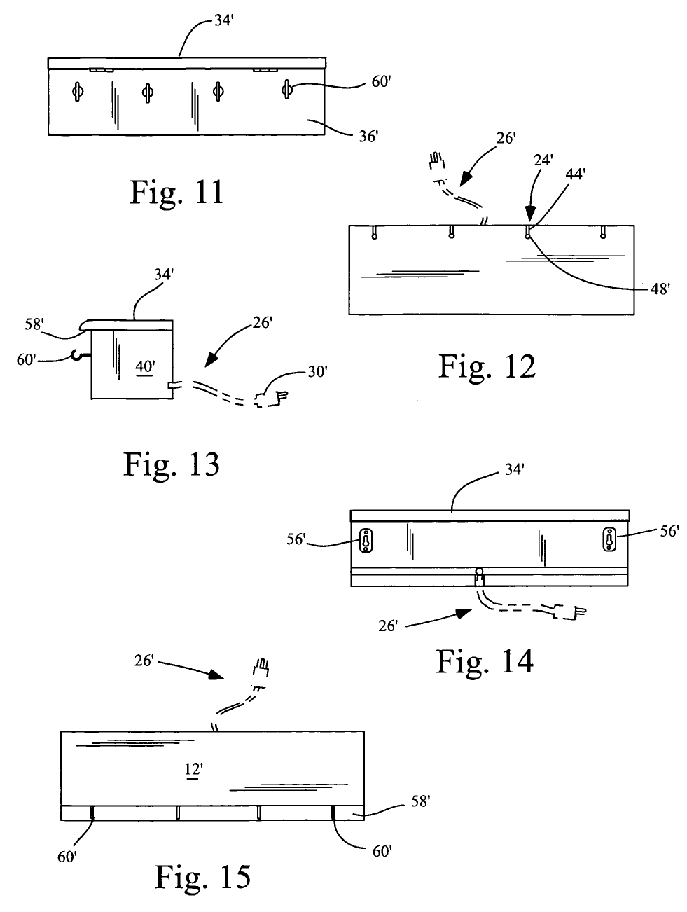

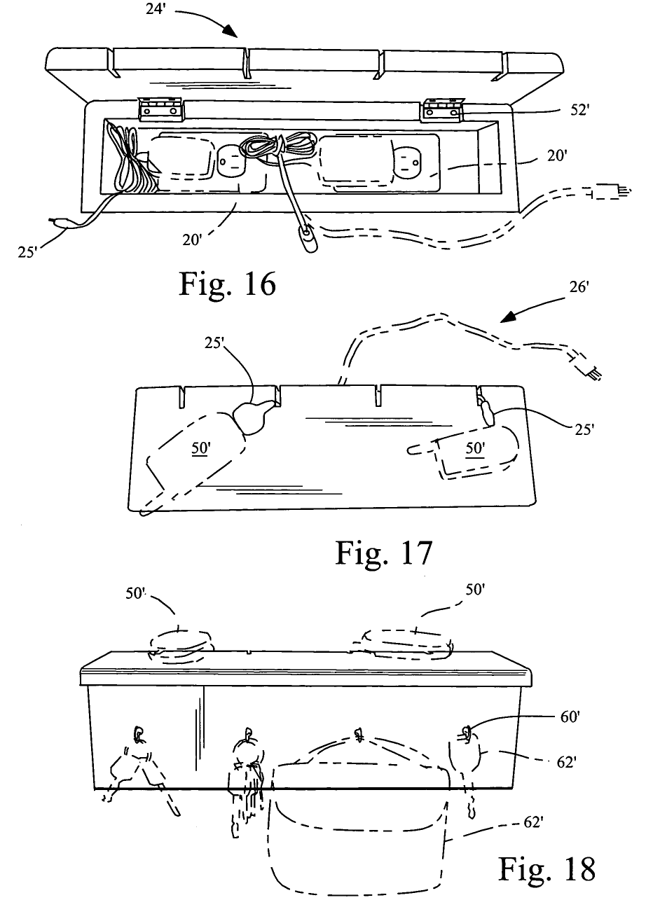

FIGS. 10 through 18 show another embodiment 10′ of the housing. This embodiment comprises two alternating current outlets 20′. As shown in these figures, this embodiment may comprise some or all of the components of the single outlet embodiment. The benefit of embodiment 10′ is that it allows at least two recharging transformers 22′, thereby allowing the recharging of multiple devices 50′

While the above is a description of various embodiments of the present invention, further modifications may be employed without departing from the spirit and scope of the present invention. For example, the size, shape, and/or material of the various components may be changed as desired. Thus the scope of the invention should not be limited by the specific structures disclosed. Instead the true scope of the invention should be determined by the following claims.

1. A housing used in combination with a recharging transformer, the recharging transformer of the type having an alternating current primary coil, the primary coil having means for conductively connecting to an alternating current outlet, the recharging transformer further comprising a secondary alternating current coil and means for rectifying alternating current from the secondary coil into direct current, the recharging transformer further comprising a direct current lead for conducting the direct current from the transformer, the housing comprising:
a bottom and a plurality of side pieces adjoining the bottom, wherein the side pieces form an opening;
an intermediate panel supported within the housing by one or more of the side pieces, the intermediate panel adapted to retain the alternating current outlet;
a first aperture wherein the first aperture provides access for the direct current outlet lead from the interior to the exterior of the housing;
a power cord having a first end connected to the alternating current outlet, wherein the power cord extends through a second aperture to the exterior of the housing and terminates at a second end, wherein the second end of the power cord is adapted to connect to an alternating current source; and
a top which fits over the opening of the housing.

2. The housing of claim 1 wherein the plurality of side pieces comprises a front panel, a back panel, a left side panel, and a right side panel.

3. The housing of claim 2 wherein the front panel and back panel are parallel to one another.

4. The housing of claim 3 wherein the front panel and back panel are each rectangular.

5. The housing of claim 2 wherein the left side panel and the right side panel are parallel to one another.

6. The housing of claim 5 wherein the left side panel and the right side panel are rectangular.

7. The housing of claim 1 wherein the first aperture is in the top.

8. The housing of claim 7 wherein the top is rectangular.

9. The housing of claim 8 wherein the first aperture comprises a restricted throat portion initiating at an edge of the top graduating to an enlarged portion inward of the edge.

10. The housing of claim 2 wherein the second aperture is in the back panel.

11. The housing of claim 4 wherein the exterior of the back panel comprises a cord groove originating at the second aperture and terminating at an edge of the back panel.

12. The housing of claim 4 wherein the exterior of the back panel comprises a tee-shaped cord groove wherein the second aperture is located at the center of the top bar of the tee.

13. The housing of claim 2 wherein the front panel comprises a plurality of utility hooks.

14. The housing of claim 2 wherein the top is hingedly connected to the front panel.

15. The housing of claim 2 wherein the back panel comprises means for hanging the housing on a wall.

16. A housing used in combination with a recharging transformer, the recharging transformer of the type having an alternating current primary coil, the primary coil having means for conductively connecting to an alternating current outlet, the recharging transformer further comprising a secondary alternating current coil and means for rectifying alternating current from the secondary coil into direct current, the recharging transformer further comprising a direct current lead for conducting the direct current from the transformer, the housing comprising:
a bottom and adjoining sides comprising a front panel, a back panel, a left side panel, and a right side panel, the adjoining sides forming an opening opposite the bottom;
a top which fits over the opening of the housing;
an intermediate panel supported within the housing by one or more of the adjoining sides, the intermediate panel adapted to retain two alternating current outlets;
one or more first apertures wherein the first apertures provide access for one or more direct current outlet leads from the interior to the exterior of the housing; and
a power cord having a first end connected to the alternating current outlets, wherein the power cord extends through a second aperture to the exterior of the housing and terminates at a second end, wherein the second end of the power cord is adapted to connect to an alternating current source.

17. The housing of claim 16 wherein the bottom, the adjoining sides, and the top form a rectangular prism.

18. The housing of claim 16 wherein the first aperture comprises a restricted throat portion initiating at an edge of the top graduating to an enlarged portion inward of the edge.

19. The housing of claim 16 wherein the exterior of the back panel comprises a cord groove originating at the second aperture and terminating at an edge of the back panel.

20. A housing used in combination with a recharging transformer, the recharging transformer of the type having an alternating current primary coil, the primary coil having means for conductively connecting to an alternating current outlet, the recharging transformer further comprising a secondary alternating current coil and means for rectifying alternating current from the secondary coil into direct current, the recharging transformer further comprising a direct current lead for conducting the direct current from the transformer, the housing comprising:
a bottom and adjoining sides comprising a front panel, a back panel, a left side panel, and a right side panel, the adjoining sides forming an opening opposite the bottom, and a top hingedly attached to the front panel, wherein the bottom, the adjoining sides and the top form a rectangular prism and the back panel comprises means for hanging the housing on a wall;
an intermediate panel supported within the housing by one or more of the adjoining sides, the intermediate panel adapted to retain two alternating current outlets;
one or more first apertures located in the top, wherein the first apertures provide access for one or more direct current outlet leads from the interior to the exterior of the housing and the first aperture comprises a restricted throat portion initiating at an edge of the top graduating to an enlarged portion inward of the edge;
a second aperture located in the back panel, wherein the exterior of the back panel comprises a tee-shaped cord groove with the second aperture located at the center of the top bar of the tee; and
a power cord having a first end connected to the alternating current outlet, wherein the power cord extends through the second aperture to the exterior of the housing and terminates at a second end, wherein the second end of the power cord is adapted to connect to an alternating current source.
